(19) United States
(12) Patent Application Publication
(10) Pub. No.: US 2010/0235461 A1
(43) Pub. Date: Sep. 16, 2010

(54) NETWORK DEVICE AND METHOD OF SHARING EXTERNAL STORAGE DEVICE

(75) Inventor: Yoshifumi HABA, Nagoya-shi (JP)

Correspondence Address: Beyer Law Group LLP, P.O. BOX 1687, Cupertino, CA, 95015-1687, US

(73) Assignee: BUFFALO INC., Nagoya-shi (JP)

(21) Appl. No.: 12/721,044

(22) Filed: Mar. 10, 2010

(30) Foreign Application Priority Data
Mar. 16, 2009 (JP) 2009-62430

(51) Int. Cl. G06F 15/167; G06F 17/30

(52) U.S. Cl. 709/213; 707/822; 707/E17.01; 707/E17.032

(57) ABSTRACT

When the external storage device is connected to the USB connector of the router, through the process of the OS which has detected this event, it will be determined whether the device is a USB mass storage device; and if it is found to be a USB mass storage device, internal software is started up by using Hotplug function, and it is further determined whether the file system is recognizable; and if the file system is recognizable, CIFS is configured to allow sharing and enable GUEST access. As a result, no laborious operation is needed to share a memory device such as a hard disk among users on a network.

### CROSS-REFERENCE TO RELATED APPLICATION

The present application claims priority from Japanese application P2009-62430A filed on Mar. 16, 2009, the content of which is hereby incorporated by reference into this application.

### BACKGROUND OF THE RELATED ART

This invention relates to a network device for use on a network, and to a method of sharing an external storage device among users on a network.

Network Attached Storage (NAS) is a well-known art according to which an external storage device such as a hard disk is connected to a network and accessed by various other devices that are connected to the network. Since NAS can be accessed without any restriction by devices such as terminals on the network, it is quite convenient to use. JP-A-2008-28971 discloses such an art. More recently, an art has been proposed according to which an access point or a router is provided with USB connectors, with which an external storage device such as a hard disk is connected so as to be used as NAS through various settings.

However, it must be noted that a difficulty is encountered when an external storage device such as a hard disk is connected directly to a network for shared use among users on the network. The difficulty is that the external storage device must have a network compatible file system installed therein, which will require complicated settings before use. For example, in order to connect an external storage device to the Internet or an intranet so that it may be accessed from various terminals, the device must usually have the file system known as CIFS (Common Internet File System) installed therein.

In case where the external storage device incorporating such a file system therein is connected with an access point or a router, the settings of the file system must be performed over the network, thereby requiring knowledge on networking and file systems.

### SUMMARY

This invention, which has been made to solve at least one of the above mentioned problems, can be realized as embodiments described below.

According to a first aspect of this invention, there is provided a network device having the function of at least one of a router and a wireless LAN access point, comprising:

a connector to which an external storage device is connected;

a detector for detecting that an external storage device has been connected to the connector;

a file system recognition unit that, when the connection of the external storage device to the connector has been detected, recognizes a file system of the external storage device; and

a sharing unit that, using the recognized file system, configures the external storage device so that the device can be accessed with prescribed access rights by other devices on a network.

According to this network device, when an external storage device has been connected to the connector, this event is detected, the file system of the external storage device is recognized, and by using the recognized file system, the external storage device will be configured so that it can be accessed by other devices on the network. Consequently, NAS can be set up simply by connecting the external storage device to the network device having router functionality, without the time and effort of making complicated settings.

According to a second aspect of this invention, there is provided a network device as described in the first aspect above, wherein the connector is a USB connector. Where the connector is compliant with the USB standard, it will be quite versatile so that various types of external storage devices can be connected. Alternatively, in place of a USB connector or in addition to a USB connector, there could be provided a connector compliant with some other standards, such as IEEE 1394, Ethernet (trade mark), or SCSI. Moreover, it is not essential for the connector to be a physical one, but it could instead be realized as a non-hardware configuration based on a wireless connection such as wireless USB. In this case, the connector may be equivalent to a function for achieving connection wirelessly.

According to a third aspect of this invention, there is provided a network device as described in the first aspect above, wherein the external storage device is a device recognized as a USB mass storage. Such devices include USB compliant hard disks, flash memories, etc.

According to a fourth aspect of this invention, there is provided a network device as described in the first aspect above, wherein an operating system is installed on the network device; the detector is realized as a function for detecting the connection of a device to the connector, the function being part of the function of the operating system; and the file system recognition unit is realized through recognition of the format of the external storage device by a prescribed program that is started up by the operating system.

Where this feature is adopted, functions can be apportioned to the operating system and a dedicated program so that detecting and sharing of the external storage device may be accomplished easily.

According to a fifth aspect of this invention, there is provided a network device as described in the first aspect above, further comprising:

a web server for distributing information on a screen for configuring the network device over the network;

a file system configuration unit that, when the network device has been configured through access to the web server from a computer on the network, formats the external storage device and installs a prescribed file system in the external storage device; and

a sharing unit that, using the configured file system, configures the external storage device so that the external storage device can be accessed by other devices on the network.

Where this feature is employed, an external storage device can be formatted and a prescribed file system can be installed on the external storage device through instructions issued from another computer on the network; and by using this file system, the external storage device can be made accessible by other devices on the network. Thus, even if the system initially installed in the external storage device is not suited to being shared on a network, the device can easily be shared through an instruction issued from a computer on the network. Moreover, these instructions can be accomplished through configuration by using a browser, so the user will not need to use dedicated software.

According to a sixth aspect of this invention, there is provided a method for sharing among (unspecified) users on a network an external storage device connected with a network device having a function of a router for use in the network, comprising:

detecting that the external storage device has been connected to the network device;

recognizing a file system of the external storage device upon detection of the connection; and

configuring, by using the recognized file system, the external storage device so that the device can be accessed with prescribed access rights by other devices on the network.

This invention may be embodied not only as the method set forth above but also as a program to be executed by a computer installed in the network device.

### BRIEF DESCRIPTION OF THE DRAWINGS

FIG. 1 is an illustration depicting a network that employs a router 30 according to an embodiment of this invention;

FIG. 2 shows in block diagram the internal structure of the router 30 shown in FIG. 1;

FIG. 3 is a flowchart showing some of the functions of the OS installed in the router 30; and

FIG. 4 is a flowchart showing the content of a program that is stored in the router 30, and executed when called by the OS.

### DESCRIPTION OF THE EMBODIMENTS

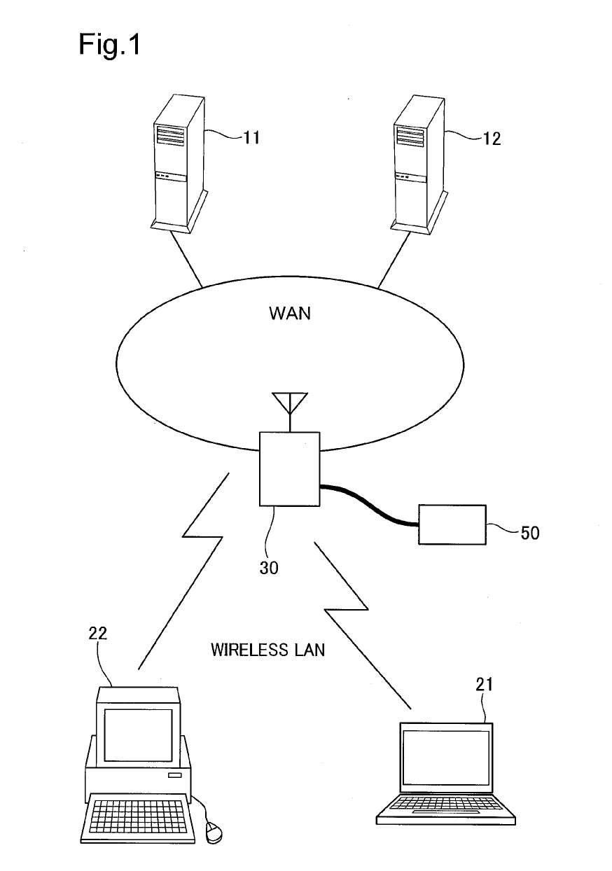

The modes of rendering the invention to practice will be described below based on an embodiment of this invention. FIG. 1 is an illustration depicting a network that employs a router 30 according to an embodiment of this invention. As illustrated, the router 30 serving as the network device of the embodiment is designed to be connected to an external storage device 50. This router 30 includes the function for serving as a wireless LAN access point, and an interface for connecting to a WAN. This type of router is generally called a “broadband router”. In this embodiment, the WAN is assumed to be the Internet; computers 21 and 22 that make up a network can access, through their wireless LAN functions, servers 11 and 12 on the Internet via the router 30. The router 30 may lack such WAN connectivity. Also, the router 30 may have only router functionality, and lack wireless LAN access point functionality.

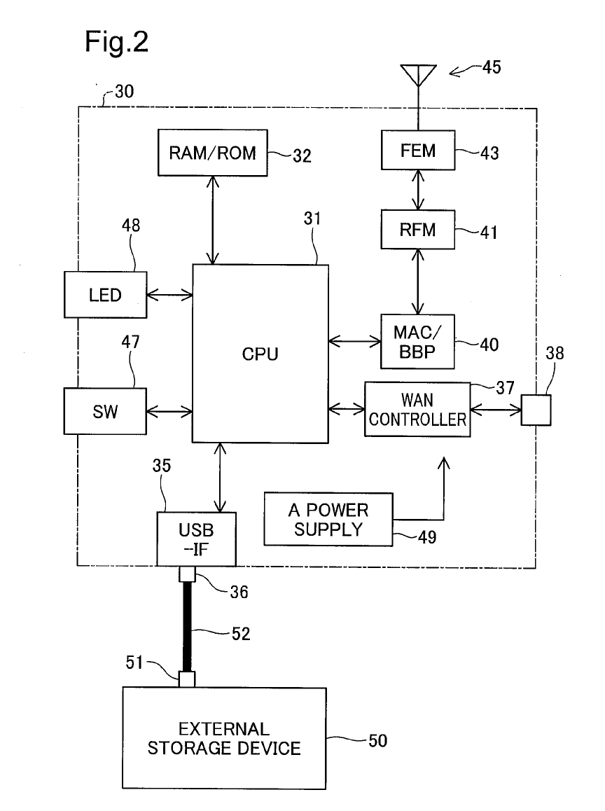

The internal structure of the router 30 is schematically shown in FIG. 2. As illustrated, this router 30 is built with a CPU 31 as a main component, and further includes a memory (RAM/ROM) 32 serving as a main memory; a USB interface (USB-IF) 35 compliant with the USB standard; a WAN connector 38 for connection to an external circuit; a controller 37 for controlling the WAN interface; a MAC/baseband processor (MAC/BBP) 40 for controlling wireless LAN functions; a modulation module (RFM) 41 connected to the MAC/BBP 40 to perform modulation for the LAN; and a front end module (FEM) 43 coupled between an antenna 45 and the RFM 41 so as to separate the transmitted and received signal waves from each other. In this embodiment, an external communication device for connection to the Internet, such as, for example, an ONU from an optical fiber line, a CATV modem, or an ADSL modem is connected to the WAN connector 38.

The router 30 is additionally furnished with a switch 47 for performing various settings of the router 30; plural LEDs indicating the status of the router 30; and a power supply 49 for supplying power to the router as a whole. The router 30 is also provided with a master-side connector 36 compliant with the USB standard, which is electrically connected to the USB-IF 35.

A variety of USB-compliant devices can be connected to the connector 36. In this embodiment, a USB-compliant hard disk, serving as the external storage device 50, is connected to the connector 36. A USB memory that uses flash ROM may, of course, be connected to the connector 36. A USB cable is used to connect the external storage device 50 with the connector 36. Actual connection can be made by inserting the terminals provided at both the ends of the USB cable into the connector 36 on the side of the router 30 and the connector 51 on the side of the external storage device 50, respectively.

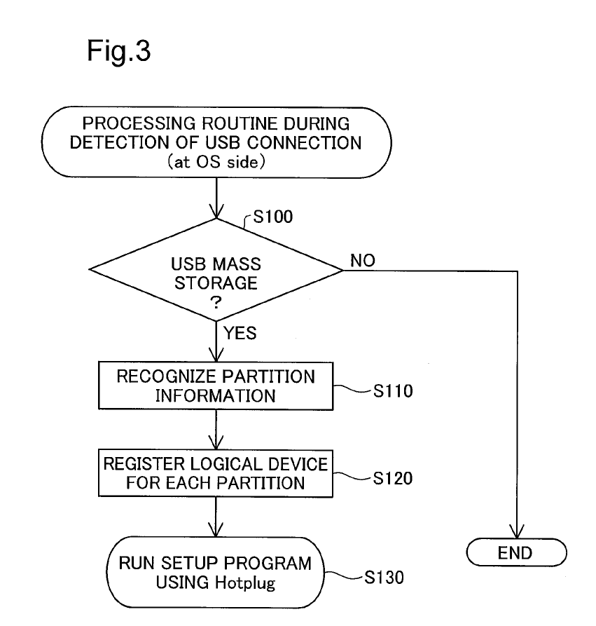

An operating system (OS) is installed on the router 30. In the router 30 of this embodiment is installed the Linux (trade mark). This type of an OS incorporates therein preinstalled device drivers for recognition and control of a standardized bus such as, for example, a regular USB bus. Consequently, when the external storage device 50 is connected to the USB connector 36, the OS operating in the router 30 recognizes the connection and starts up a prescribed routine. The processing routine is shown in FIG. 3. In place of installing and using an OS in this way, it may also be possible to execute a dedicated monitor program which serves in function as the router, monitors the USB-IF 35 always, and detects the connection of the USB device to the connector 36. The OS, since it has as its standard function the function of detecting the connection of such a USB device, was used in this embodiment.

When the connection of a USB device to the connector 36 is detected, the OS initiates the process shown in FIG. 3. Once this processing routine is initiated, it is first determined whether the USB device that has been connected to the connector 36 is a USB mass storage device (Step S100). The determination as to whether the device is USB mass storage is made by a USB driver included in the OS.

If the determination is that the USB device that has been connected to the connector 36 is a USB mass storage device, then a process to recognize partition information will be carried out (Step S110). If the USB device is a USB mass storage device, it can have multiple partitions, and therefore the USB mass storage device must be recognized. Here, if there are plural USB devices connected to the connector 36 (e.g. in the case of a USB hub with several devices connected thereto, or a USB device incorporating multiple drives therein), the recognition of partition information is carried out for each of the plural USB devices. If the connected USB device is not a USB mass storage device, the USB connection detection processing routine shown in FIG. 3 is terminated by the OS. In this case, no particular process is carried out.

After Step S110, a process to record the recognized partitions as respective logical devices is carried out (Step S120). Partitioning is to divide the memory area of the external storage device 50 such as a hard disk into areas of prescribed size. If the respective partitions are regarded as so many separate logical devices, they may be treated as plural memory devices from outside. In this case, the number of partitions registered as logical devices may be limited to, for example, four at maximum. Alternatively, only a single partition may be registered, or all partitions may be registered as logical devices. Registration of partitions may take place according to a particular order specified within the external storage device 50, an order specified in accordance with memory area sizes, or according to the types of file systems discussed later.

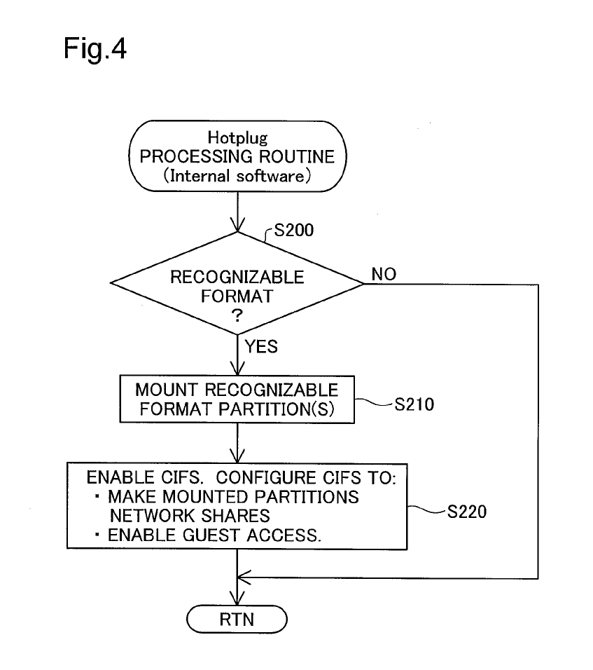

After the above process has been completed, the OS starts up a prescribed setup program by utilizing a Linux function known as “Hotplug” (Step S130). According to Hotplug, the names of program files desired to start up are listed in advance in the configuration files managed by the OS so that control may be transferred from the OS to one of these program files. In this embodiment, by utilizing this function, processing is transferred to the internal software shown in FIG. 4.

Now, described is the Hotplug processing routine which is the internal software shown in FIG. 4. When this internal software is started up through the function of the OS, the file systems allocated to the respective partitions of the external storage device 50 are first checked to determine whether they have recognizable formats (Step S200). In this embodiment, if the file systems are of XFS, FAT12, FAT16, or FAT32 format, they can be shared among users over the network. Therefore, the determination as to whether they are of XFS, FAT12, FAT16, or FAT32 format, is made for the individual partitions of the external storage device 50. During this process, the internal software itself may check the file systems, or it may use the standard function of the OS in order to access information relating to the file systems being used. In this embodiment, such information is obtained from the OS.

If the file system checked in each partition is one of the systems XFS, FAT12, FAT16, or FAT32, a process to mount the previously registered logical device onto the partition using one of these file systems will be carried out so as to enable access to the file system in the partition (Step S210). At this time, the previously registered logical devices may be mounted onto all partitions having recognizable file systems, or onto limited one or N (N is an integer equal to or greater than 2) partitions. In this embodiment, four logical devices are mounted at most. In case where the number of logical devices to be mounted is to be limited, mounting may be carried out according to some criterion such as the order in which they were registered as logical devices, or in order of the magnitudes of memory capacities. Partitions may also be selected randomly for logical device mounting.

Next, a process is carried out to enable CIFS (Common Internet File System) and make the following CIFS settings in the Step S220:
to have all partitions on which logical devices are mounted, shared among users on network
to enable GUEST access.
   Here, GUEST access is a setting whereby shared partitions may be accessed without user authentication.

In practice, the parameters for making the above settings is written in the configuration files used by the file sharing system (in this embodiment, “Samba” is used) managed by the OS, and then the file sharing system Samba is started. Samba is normally OFF (not yet started) when the router 30 is started up, but in the event that Samba has already been started up due, for example, to a setting made by the user, Samba has only to be restarted in like manner as described above after rewriting the configuration file. Also, in place of enabling GUEST access, the system may be set up to carry out user authentication through user IDs and passwords that have been previously saved in the router 30. User IDs and passwords may be provided to users beforehand, so that the user can input these IDs and passwords when the users access the shared external storage device 50 from the computer 11, or 12 on the network. Such IDs and passwords may be provided to the user by, for example, being indicated on the chassis of the router 30 or listed in the user manual. Computers (user terminals) on the network may be notified with regard to successful completion of sharing and to access method as well. Methods for such notification include using emails, and the “push” technique whereby user IDs and passwords are delivered from the router 30 to computers connected to the network.

After the above process has been executed, the flow passes to RTN, the Hotplug process routine terminates, and process control returns to the OS which called the Hotplug process routine. An additional process or processes may be also executed before process control returns to the OS. For example, the LED 48 may be illuminated to show the successful completion of sharing of the external storage device 50.

Accordingly, as a result of the processes shown in FIGS. 3 and 4, if a user simply connects the external storage device 50 to the USB connector 36 of the router 30, the external storage device 50 can be automatically mounted on the network and shared among other users connected to the network, with no input of any kind required from the user. Thus, each partition of the external storage device 50 connected to the router 30 can be recognized as a shared drive by the computers 21, and 22 on the network, and NAS functionality may be achieved in a very simple manner. Moreover, plural partitions can be shared as so many different logical devices, making them even easier to handle.

According to this embodiment, immediately after sharing has been set up, GUEST access will be enabled (authentication unnecessary), or pre-assigned user IDs and passwords will be registered, and user authentication will be carried out using these IDs and passwords. Access restrictions may be modified sometime later. Such modification of access restrictions as, for example, modification of other settings of the shared external storage device 50, is accomplished using a web server function that has been provided for the router 30. While not shown in the drawings, a web server is provided in the router 30, and by running the browser on the computer 21, or 22 on the network and entering the IP address of the web server in the router 30, a setting screen will be popped up. From this setting screen it will be possible to register a new user, change user ID and/or password, and set file write/read permissions for each registered user. The setting screen is also designed to display partitions corresponding to file systems other than XFS, FAT12, FAT16, or FAT32 as logical devices as well, and one or more of these partitions can be selected for being formatted to any of the formats XFS, FAT12, FAT16, or FAT32. By clicking a Format button displayed on the screen, the selected partition will be reformatted to a file system selected from among XFS, FAT12, FAT16, and FAT32.

While this invention has hitherto been described by way of an embodiment, the invention is not limited to this particular embodiment, but may be embodied in various other modes. For example, an OS other than Linux may be used as the OS that is run by the router 30. For example, if Windows (trade mark) is used as the OS for the router 30, a partition that emulates a CD-ROM may be provided in the external storage device 50, and internal software designed to be executed by the Autorun function may be installed in this partition and used to execute processes equivalent to those shown in FIGS. 3 and 4. A USB memory or SSD (Solid State Disk) may also be employed as the external storage device 50. Moreover, a card reader may be connected to the USB connector 36, and a memory card installed in the card reader may be handled as an external storage device.

The router 30 of this embodiment is designed to allow an external storage device 50 to always be shared automatically among users when the device is connected to the connector 36, but a switch 47, for example, for setting automatic sharing on or off may be provided instead. While the router 30 described above has wireless LAN functionality, a router designed for wired LAN may be used instead, or routers adapted for both wireless or wired applications may also be used. This invention may further be embodied as an access point lacking router functions. Furthermore, two or more connectors 36 may be provided for connection of external storage devices.

While the invention has been particularly shown and described with reference to an embodiment thereof, it will be understood by those skilled in the art that various changes in form and detail may be made therein without departing from the spirit and scope of the invention as defined by the appended claims.

What is claimed is:

1. A network device having a function of at least one of a router and a wireless LAN access point, comprising:
a connector to which an external storage device is connected;
a detector for detecting that an external storage device has been connected to the connector;
a file system recognition unit that, when the connection of the external storage device to the connector has been detected, recognizes a file system of the external storage device; and
a sharing unit that, using the recognized file system, configures the external storage device so that the device can be accessed with prescribed access rights by other devices on a network.

2. A network device as claimed in claim 1, wherein the connector is a USB connector.

3. A network device as claimed in claim 1, wherein the external storage device is a device recognized as a USB mass storage.

4. A network device as claimed in claim 1, wherein
an operating system is installed in the network device;
the detector is realized as a function for detecting the connection of a device to the connector, the function being part of the function of the operating system; and
the file system recognition unit is realized through recognition of the format of the external storage device by a prescribed program that is started up by the operating system.

5. A network device as claimed in claim 1, further comprising:
a web server for distributing information on a screen for configuring the network device over the network;
a file system configuration unit that, when the network device has been configured through access to the web server from a computer on the network, formats the external storage device and installs a prescribed file system in the external storage device; and
a sharing unit that, using the configured file system, configures the external storage device so that the external storage device can be accessed by other devices on the network.

6. A method for sharing among users on a network an external storage device connected with a network device having a function of a router for use in the network, comprising:
detecting that the external storage device has been connected to the network device;
recognizing a file system of the external storage device upon detection of the connection; and
configuring, by using the recognized file system, the external storage device so that the device can be accessed with prescribed access rights by other devices on the network.
